(19) United States
(12) Patent Application Publication
(10) Pub. No.: US 2010/0074523 A1
(43) Pub. Date: Mar. 25, 2010

(54) Image classification apparatus

(75) Inventor: Kenichi Ishiga, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/585,198

(22) Filed: Sep. 8, 2009

(30) Foreign Application Priority Data
Sep. 12, 2008 (JP) 2008-235578

(51) Int. Cl. G06K 9/62; G06K 9/00

(52) U.S. Cl. 382/170; 382/224

(57) ABSTRACT

An image classification apparatus that classifies images based upon image data includes: a multiresolution representation unit that sequentially generates high-frequency band images assuming a plurality of resolution levels by filtering an original image; an image synthesis unit that synthesizes a single high-frequency band image by sequentially integrating the high-frequency band images starting with a high-frequency band image at the lowest resolution; a histogram generation unit that generates a histogram of synthesized high-frequency band image signal; and an image classification unit that classifies the original image into one of at least two image categories based upon a distribution pattern of the histogram having been generated.

### INCORPORATION BY REFERENCE

The disclosure of the following priority application is herein incorporated by reference:
Japanese Patent Application No. 2008-235578 filed Sep. 12, 2008

### BACKGROUND OF THE INVENTION

1. Field of the Invention

The present invention relates to an image classification apparatus.

2. Description of Related Art

Attempts have been made in the related art to correlate the overall impression felt by viewers of a given photographic image with an impression adjective such as “fresh” or “succulent”. Japanese Patent Publication No. 3020887 (reference 1) discloses a method whereby image impressions are approximated based upon a trichromatic representation and the impression of a photographic image is classified by referencing a database created in advance by correlating trichromatic models with specific words that express an impression.

In addition, as described in “Image Statistics and the Perception of Surface Qualities,” Nature, 2007, May 10; vol. 447 (7141) pp. 206-209” (reference 2) by I. Motoyoshi, S. Nishida, L. Sharan and E. H. Adelson, test results obtained by comparing images of a single textual scene assuming various gradations have been studied in recent years and a relation of the perceived glossiness of the surface of an object to the skew factor in the image brightness histogram or the skew factor in the band pass filter output has been noted.

### SUMMARY OF THE INVENTION

While the method disclosed in reference 1 scrutinizes the characteristics of an image related to its color through trichromatic representation, factors such as edges, texture and spatial contrast distribution are not taken into consideration at all as factors that may significantly affect the impression made by the image in the method. For instance, a test search for images classified as “manly” (“masculine”) among photographs conducted by adopting the method disclosed in reference 1, is likely to retrieve only shadowy images with dark hues and not to extract a photograph of a landscape with clear, intense contrast would actually be perceived as a clean-cut, manly image, thus the classification method often does not reflect the subjective aspect of human visual perception.

While reference 2 provides an important observation with regard to the measurement of the appearance of glossiness rendered with the texture of the surface of an object, it does not cover the area of applications dealing with human perception other than the sense of glossiness or it does not provide a clear view on how the concept may be adopted in conjunction with regular images that include all sorts of scenes.

Accordingly, an object of the present invention is to establish a systematic base that enables advanced impression-indexed search by determining features universally representing close connections between edge•texture•contrast and impression adjectives, so as to enable designation of a set of adjectives accurately expressing the impression made by a standard photographic image, which, as a whole, may include photographed therein any scenes, sites and textured areas in combination. Namely, the present invention primarily aims to detect features optimal for adjective-based classification along an axis related to edge, texture and contrast.

According to the 1st aspect of the present invention, an image classification apparatus that classifies images based upon image data comprises: a multiresolution representation unit that sequentially generates high-frequency band images assuming a plurality of resolution levels by filtering an original image; an image synthesis unit that synthesizes a single high-frequency band image by sequentially integrating the high-frequency band images starting with a high-frequency band image at the lowest resolution; a histogram generation unit that generates a histogram of synthesized high-frequency band image signal; and an image classification unit that classifies the original image into one of at least two image categories based upon a distribution pattern of the histogram having been generated.

According to the 2nd aspect of the present invention, it is preferred that in the image classification apparatus according to the 1st aspect, the image classification unit classifies the original image based upon an asymmetry of the distribution pattern of the histogram.

According to the 3rd aspect of the present invention, it is preferred that in the image classification apparatus according to the 2nd aspect, the image classification unit indicates the asymmetry of the distribution pattern of the histogram as a feature representing a skew factor of the histogram.

According to the 4th aspect of the present invention, it is preferred that in the image classification apparatus according to the 2nd aspect, the image classification unit indicates the asymmetry of the distribution pattern of the histogram as a feature representing offsets of central coordinate points of distribution widths at least at two specific heights relative to a height of a central peak in the histogram.

According to the 5th aspect of the present invention, it is preferred that in the image classification apparatus according to the 1st aspect, the image synthesis unit synthesizes the high-frequency band image by integrating high-frequency band images assuming at least three different resolution levels.

According to the 6th aspect of the present invention, it is preferred that in the image classification apparatus according to the 1st aspect, the image classification unit classifies an impression received from a single image as a whole into adjective.

According to the 7th aspect of the present invention, it is preferred that in the image classification apparatus according to the 1st aspect, the histogram generation unit generates the histogram of the synthesized high-frequency band image signal for one of a luminance plane and a chromaticity plane, or for both the luminance plane and the chromaticity plane.

According to the 8th aspect of the present invention, it is preferred that in the image classification apparatus according to the 1st aspect, the multiresolution representation unit makes characteristics of perceptively uniform contrast signals reflected in the high-frequency band images by generating the high-frequency band images in a nonlinear gradation uniform color space.

According to the 9th aspect of the present invention, an image classification apparatus that classifies images based upon image data comprises: a multiresolution representation unit that sequentially generates high-frequency band images assuming a plurality of resolution levels by filtering an original image; an image synthesis unit that synthesizes a single high-frequency band image by sequentially integrating the high-frequency band images starting with a high-frequency band image at a lowest resolution; and an image classification unit that classifies an impression that human viewers receive from the original image into an adjective based upon the synthesized high-frequency band image.

According to the 10th aspect of the present invention, an image classification apparatus that classifies images based upon image data comprises: a histogram generation unit that generates a histogram of image signals having projected therein specific characteristics of an original image; a feature calculation unit that calculates a feature used to distinguish a given single type of pattern characteristics among patterns of the histogram having been generated; and an image classification unit that classifies an impression that human viewers receive from the original image into an adjective based upon the feature, wherein: the feature calculation unit calculates at least two different types of indices as features for distinguishing the single type of pattern characteristics.

According to the 11th aspect of the present invention, it is preferred that in the image classification apparatus according to the 10th aspect, the feature calculation unit calculates an index sensitive to part of the characteristics of the histogram and an index less sensitive to the part of the characteristics of the histogram as the two different types of indices.

According to the 12th aspect of the present invention, it is preferred that in the image classification apparatus according to the 11th aspect, the feature calculation unit calculates two types of features, one constituting an index sensitive to characteristics manifesting over a tail area in the histogram pattern and another constituting an index less sensitive to the characteristics assumed in the tail area in the histogram pattern as features used to distinguish the asymmetry of the histogram.

According to the 13th aspect of the present invention, it is preferred that in the image classification apparatus according to the 10th aspect, the feature calculation unit calculates an index related to a third-order or higher-order moment for an average value of the histogram and an index related to a quantity that can be defined by measuring coordinates of a distribution range at a predetermined height relative to a peak of the histogram as the two different types of indices.

### BRIEF DESCRIPTION OF THE DRAWINGS

FIG. 1 shows a schematic distribution of impression adjectives to be referred to as an example;

FIGS. 2A˜2C present an example of a “masculine” sample image, with FIG. 2A showing the original image, FIG. 2B showing a synthesized edge image of the V (luminance) plane and FIG. 2C showing a probability density function (pdf) of the synthesized edge image;

FIGS. 3A˜3C present an example of a “masculine” sample image, with FIG. 3A showing the original image, FIG. 3B showing a synthesized edge image of the V (luminance) plane and FIG. 3C showing a probability density function (pdf) of the synthesized edge image;

FIGS. 4A˜4C present an example of a “feminine” sample image, with FIG. 4A showing the original image, FIG. 4B showing a synthesized edge image of the V (luminance) plane and FIG. 4C showing a probability density function (pdf) of the synthesized edge image;

FIGS. 5A˜5C present an example of a “feminine” sample image, with FIG. 5A showing the original image, FIG. 5B showing a synthesized edge image of the V (luminance) plane and FIG. 5C showing a probability density function (pdf) of the synthesized edge image;

FIG. 6 presents an example of a “masculine” pdf distribution;

FIG. 7 presents an example of a “feminine” pdf distribution;

FIG. 8 presents an example of an image search apparatus;

FIG. 9 presents a flowchart of the model creation processing executed by the PC;

FIG. 10 presents a flowchart of the image search processing executed by the PC;

FIG. 11A shows an RGB image, FIG. 11B shows a hue plane image, FIG. 11C shows a luminance plane image and FIG. 11D shows a chromaticity plane image;

FIG. 12 shows how an image is divided into subbands through wavelet transformation;

FIG. 13 shows high-frequency subband planes and the corresponding probability density function (pdf) distributions at various resolution levels;

FIG. 14A presents an example of a synthesized edge image and FIG. 14B shows the corresponding pdf distribution;

FIG. 15 presents a diagram illustrating how the eboshi factor may be defined;

FIG. 16 presents a two-dimensional map table related to the asymmetry (the skew factor and the eboshi factor) of the V plane pdf curve;

FIG. 17 presents an example of a two-dimensional map;

FIGS. 18A˜18C present an example of a “glorious” sample image, with FIG. 18A showing the original image, FIG. 18B showing a synthesized edge image of the V (luminance) plane and FIG. 18C showing a probability density function (pdf) of the synthesized edge image;

FIG. 19 schematically illustrates an example of feature space optimal for perception indexed search; and

FIG. 20 is a block diagram of the essential structure adopted in the PC in the embodiment.

### DESCRIPTION OF PREFERRED EMBODIMENT

The following is a description of a preferred embodiment of the present invention, given in reference to the drawings.

(Preliminary Explanation)

Before describing the specific algorithm used in the embodiment, the principal findings substantiating the validity of the algorithm having been obtained through testing, are described in reference to several examples. Namely, in the search for any rule that may exist with regard to the relationship between photographic images and impression adjectives, basic data pairing up the photographic images with specific impression terms, to be used for evaluation, were collected and a model was created whenever common characteristics were found in images assigned with a common adjective and the model thus created was utilized as an impression-indexed image search means.

(A) Collecting Evaluation Data to be Used for Evaluation of the Correlation Between Impression Adjectives and Actual Photographic Data.

First, in order to create basic data indicating impression left by actual photographic data, several hundred photographs of various types of images, including landscapes, portraits, street scenes and close-ups were each assigned with one adjective or up to several adjectives whenever a single adjective seemed inadequate, deemed to most accurately express the impression imparted by the overall image, chosen from general Japanese adjectives.

While some of the adjectives assigned to the photographic images, such as “sparse”, were adjectives commonly used to describe photographic compositions, many photographic images upon scrutiny, each prove to match in approximation at least one of 473 adjectives often used to express color perception. These 473 adjectives are listed in the appendix to the following reference (*1)

(*1) “Color Science”, compiled by the Japanese Society of chromatics, color science series 1, 2004, published by Asakura Shoten, ISBN 4-254-10601-7

In addition, quoted reference (*2) cited in reference 1 as a database lists 180 words as typical impression adjectives.

(*2) “Color Image Scale” (revised), by Shigenobu Kobayashi, Nippon Color & Design Research Institute Inc., 2006, published by Kodansha, ISBN 4-06-210929-8

These adjectives include a number of words assumed to clearly reflect by human visual perception closely related to edge structures, texture structures and contrast intensity. Namely, information related to edges, textures and contrast can be considered to be a factor that greatly affects human visual perception. For instance, an image of trees, taking on intense contrast, standing straight up towards a clear sunny sky was assigned with the adjective “gallant” and an image of a craggy landscape was assigned with adjectives such as “masculine”, “rough” and “forceful”. In contrast, relatively placid, calm images were assigned with adjectives such as “mild”, “feminine”, “congenial” and “mellow”.

(B) Relationship Between Perception Terms (Adjectives) and Physical Quantities and Creation of Kansei Models or Perception Models

The human mind is assumed to take in information related to edges, textures and contrast as information expressing the overall image and to quickly determine the perceptional impression as a single set of information. Namely, it is more desirable to create an integrated criterion model for a feature to be used for impression-indexed classification, rather than a model for dividing the target image into separate parts and analyzing each part in detail. The quantity of texture information that may be optimal for such a system can be generated by taking full advantage of the characteristics of multiresolution representation. Namely, by detecting edges at multiple resolutions and integrating sets of texture information and contrast information corresponding to the various resolution levels through multiresolution synthesis, a single set of integrated contrast information is obtained. The inventor of the present invention surmised that it might be possible to directly scrutinize the overall impression of the image corresponding to the single set of integrated information by analyzing signals in the integrated contrast information. Accordingly, all the evaluation data were analyzed in order to statistically investigate whether or not signals assuming common characteristics might be detected in correspondence to a given adjective.

The investigation was conducted by first sorting the evaluation data into two types in order to facilitate initial projection of specific perception elements likely to be found in various units of integrated edge information. It was surmised that the first impression imparted by a given set of edge•texture•contrast structure information may be assigned to either a “masculine” group or a “feminine” group through broad categorization. Namely, it was proposed that the impressions received from images may be classified based upon the premise that the “masculine” elements become more dominant further away to one side from the origin point and the “feminine” elements become more dominant further away to the other side of the origin point, relative to an aggregate axis representing a feature vector related to edges, textures and contrast. It was further argued that finer adjective classification may be possible by scrutinizing various parts of the aggregate.

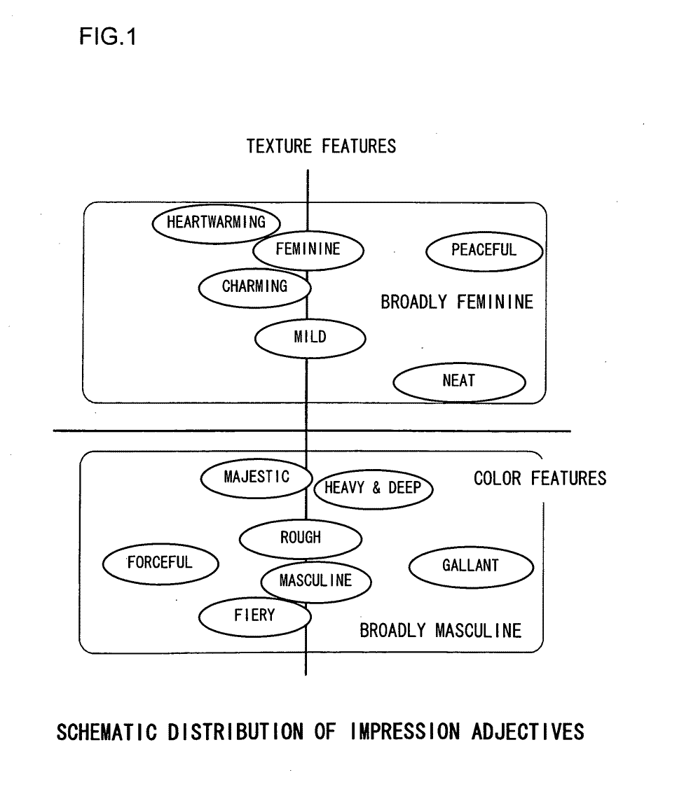

The impression adjectives belonging to the broad categorization “masculine” may include “gallant”, “rough”, “forceful”, “heavy and deep”, “majestic” and “fiery”, whereas the impression adjectives belonging to the broad categorization “feminine” may include adjectives such as “mild”, “heartwarming”, “cute”, “generous”, “tolerant”, “neat” and “peaceful”. In other words, the adjectives in the “masculine” group on the whole invoke a sense of hardness, whereas the adjectives in the “feminine” group on the whole invoke a sense of softness. FIG. 1 presents a diagram illustrating this concept.

Through the investigation, it was learned that there was a marked difference between the distribution patterns of the histograms (probability density function) of synthesized edge signals obtained through multiresolution synthesis executed for a group of images among the evaluation data likely to be classified as “masculine” in the broad sense, and the distribution patterns of the histograms of synthesized edge signals obtained through multiresolution synthesis executed for a group of images among the evaluation data likely to be classified as “feminine” in the broad sense. Namely, the characteristics of the images classified as “masculine” and the characteristics of images classified as “feminine” are evinced in different forms of asymmetry in the probability density function (pdf) distribution pattern. The different characteristics represented by these two adjectives appear to be particularly clearly reflected in the different forms of asymmetry assumed in the luminance component pdf distribution patterns. Two typical distribution examples, together with corresponding images, are provided for each perception term.

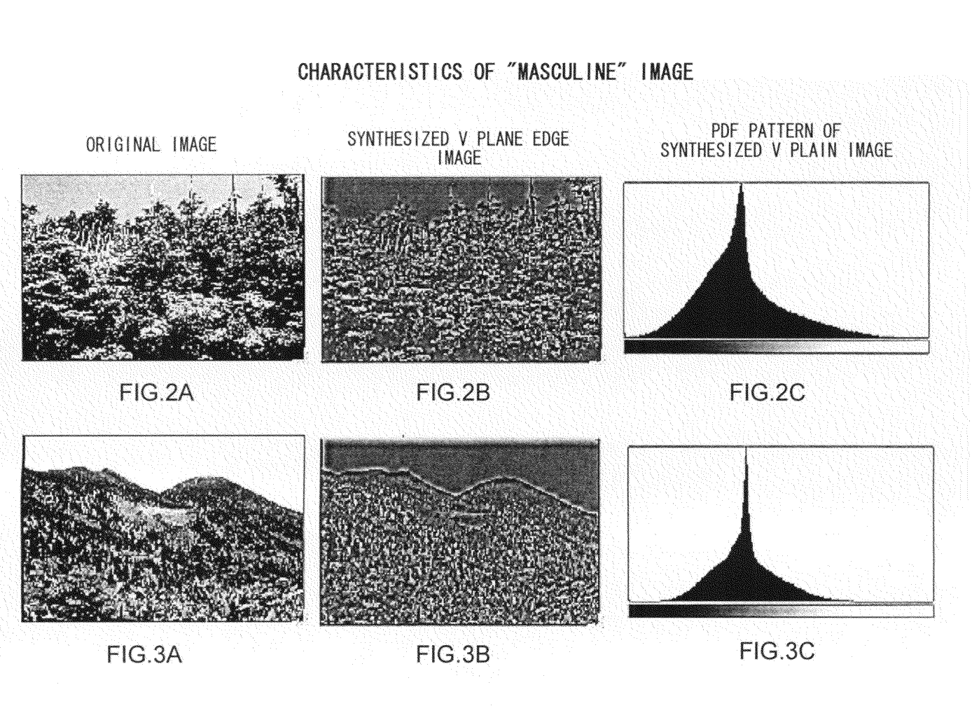

FIGS. 2A through 2C and FIGS. 3A through 3C present examples corresponding to “masculine” sample images. FIGS. 2A and 3A each show an original image. FIGS. 2B and 3B each show a synthesized edge image corresponding to the V (luminance) plane. FIGS. 2C and 3C each show the synthesized edge image probability density function (pdf) distribution pattern.

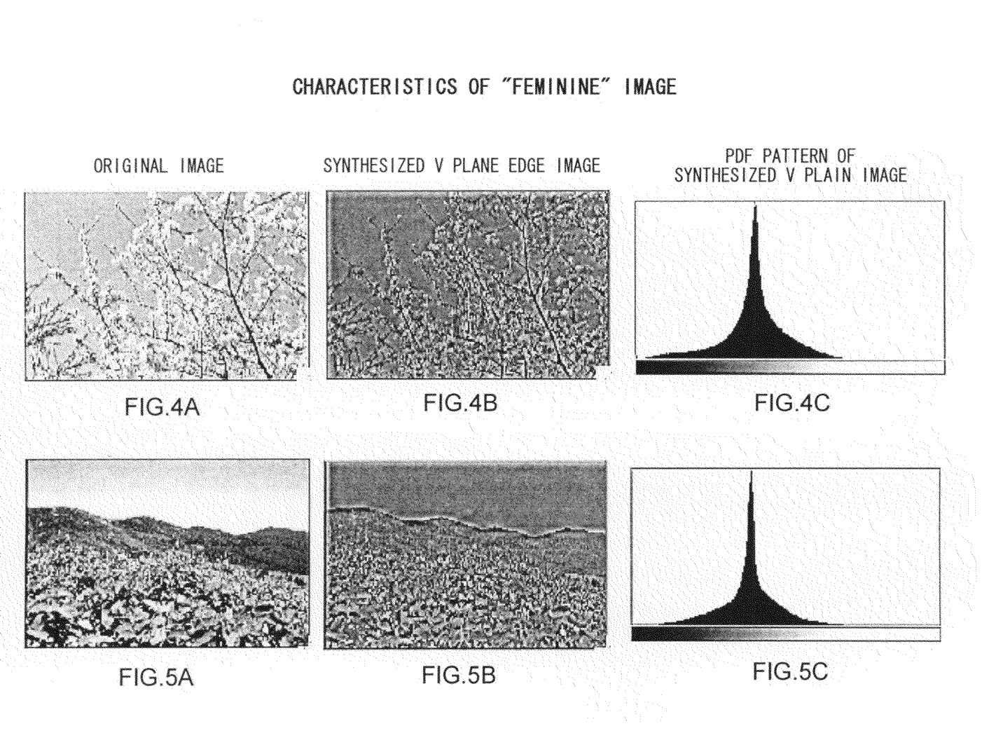

FIGS. 4A through 4C and FIGS. 5A through 5C present examples corresponding to “feminine” sample images. FIGS. 4A and 5A each show an original image. FIGS. 4B and 5B each show a synthesized edge image corresponding to the V (luminance) plane. FIGS. 4C and 5C each show the synthesized edge image probability density function (pdf) distribution pattern.

It is of critical note that the pdf distribution of each of the high-frequency subband images generated through multiresolution transformation, normally assuming a symmetrical form as a memoryless source, is known to be approximated with the generalized Gaussian distribution f(x)=a*exp(−|x−m)/b|̂α) including Gaussian distribution and Laplacian distributions. This fact allows us to surmise that a pdf distribution assuming an asymmetrical form indicates detection of prominent characteristics.

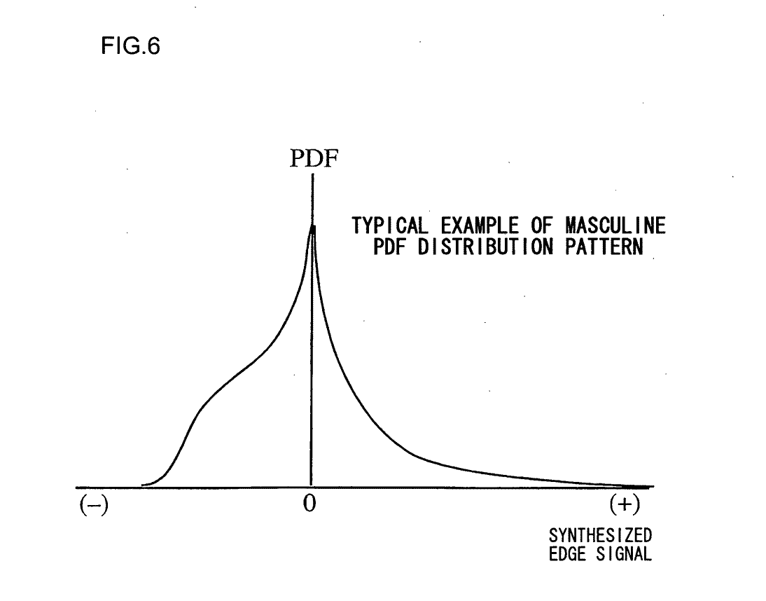

A great number of the “masculine” images are statistically known to assume pdf distributions taking on forms such as that of the example presented in FIG. 6, with the side of the triangle over the negative range taking on the shape of an upward curve with a convex bulge and the side over the positive range taking on the shape of a downward concave curve. The relation of this distribution pattern to the signals observed within a masculine image may be interpreted as follows. Namely, the image is likely to contain solid, dark image areas with craggy outlines, sustaining specific areal sizes at various resolution scales, and these areas are in intense contrast with bright image areas even if these areas are miniscule. Assuming that similar phenomena occur over similar spatial locations at a plurality of resolution levels, a succession of the phenomena manifest as an asymmetrical form in the synthesized edge contrast intensity frequency distribution.

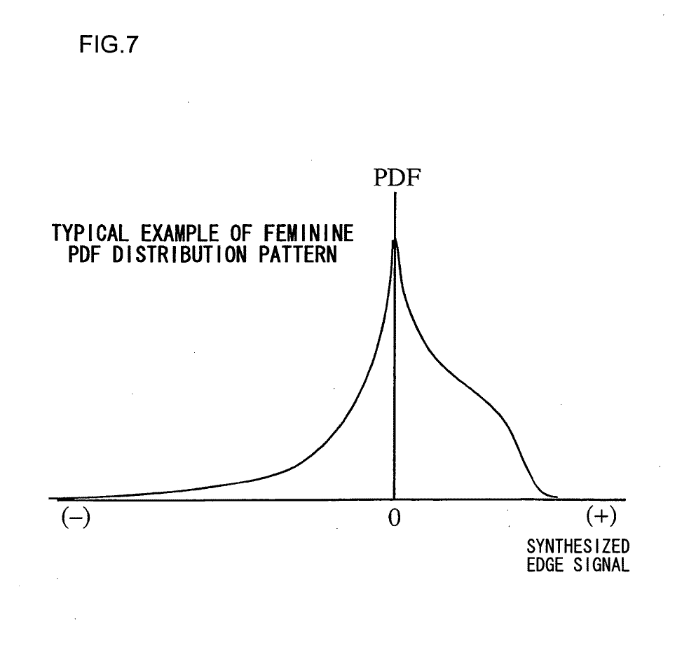

Images classified as “feminine”, on the other hand, may assume pdf distributions taking on forms such as that of the example presented in FIG. 7, which are the inverse of the “masculine” pdf distribution patterns. The formation of an inverse pdf distribution pattern may be interpreted as follows. Namely, such a contrast structure often manifests in an image containing a structural element taking up a small area with an edge thereof taking up a miniscule area, as if the structural element had been delicately sketched with a pencil or chalk, within a large image area that does not manifest any significant change overall and sustains an average brightness level. Accordingly, in a photograph of, for instance, a large ship taking up most of the image plane, the image area taken up by the body of the ship and the background is the large area mentioned above, whereas a small structural element on the deck such as the ship's bridge corresponds to the small image area and then, the image creates a feminine impression, befitting the fact that ships are referred to as “she” in English. In a landscape photograph, a solid expanse of sky, ocean, field or the like will be the large image area and a structural element in the photographic image such as a small farm house will be equivalent to the small image area assuming a certain contrast against the large image area, which invokes a calm, enveloping impression.

In addition, it has been confirmed that a “feminine” image does not always assume an inverse pdf distribution pattern but there are feminine images with pdf distribution patterns manifesting extremely complex and delicate behavior. For instance, a “feminine” impression may be suggested by an image with a pdf distribution thereof taking on a substantially symmetrical form but manifesting a subtle asymmetry toward the bottom of the triangle. This means that it tends to be difficult to set forth a valid stereotype of the “feminine” distribution pattern and that it makes better sense to regard as “feminine” any image that cannot be categorized as “masculine”. It may even be argued that such delicate and complicated behavioral patterns are analogous to the complexity of human sensibility.

As has been described, when the edge contrast data detected at a plurality of resolution levels are integrated, the spatial positional relationships of texture structures and other image structures are reflected in succession through a plurality of resolution levels, and thus even if a symmetrical pdf distribution pattern is assumed on each band plane, the pdf distribution of the synthesized image manifests asymmetry depending upon the scene of the image. Namely, the pdf distribution pattern of the synthesized edge data reflects characteristics information indicating the characteristics of perception invoked by the spatial positional relationship of contrast data at different resolution levels. Accordingly, a feature representing the pdf distribution pattern may be used as a vector element constituting the principal axis of features related to texture in order to create an abridged feature space optimal for impression-indexed classification.

### EMBODIMENT OF THE INVENTION

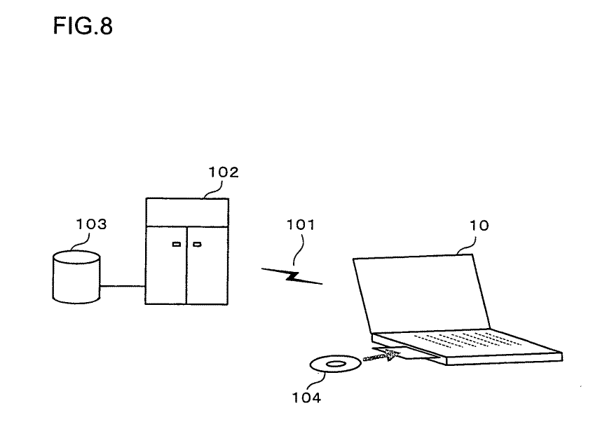

Bearing in mind that a valid method for creating perception models has been proposed as described above, an image search apparatus that searches for an image in a database based upon a perception keyword (adjective) is described. FIG. 8 presents an example of the image search apparatus. The image search apparatus is constituted with a personal computer 10. The personal computer 10, connected with a digital camera, a memory card reader, another computer or the like, not shown, takes in electronic image data and stores the image data thus taken in into a storage device (e.g., a hard disk device). The personal computer 10 executes an image search to be detailed later by searching through the accumulated image data.

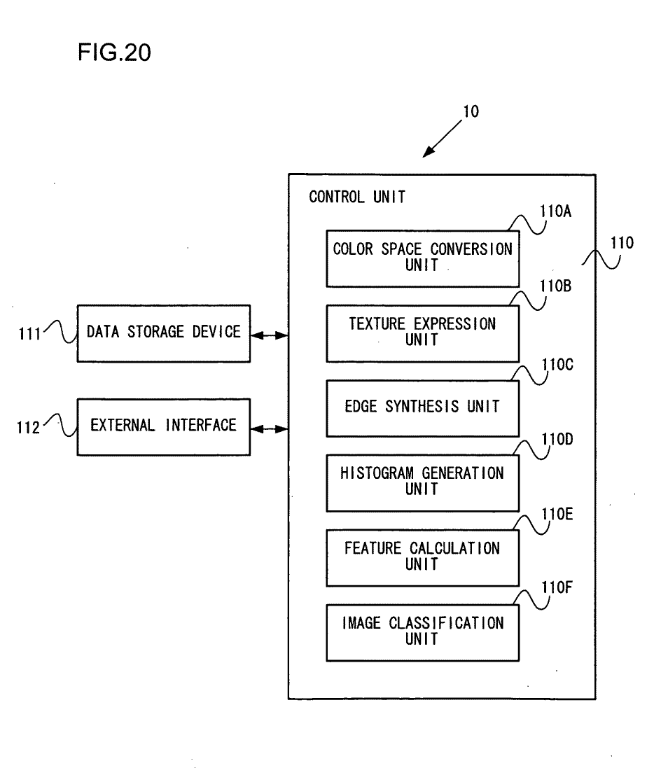

A program may be loaded into the personal computer 10 by loading a recording medium 104, such as a CD-ROM having the program stored therein, into the personal computer 10, or via a communication line 101 such as a network. The program stored in, for instance, a hard disk device 103 of a server (computer) 102 connected to the communication line 101 can be downloaded into the personal computer 10 via the communication line 101. A title assigning program can be distributed as a computer program product assuming any of various modes including the recording medium 104 and the communication line 101. At the personal computer 10, constituted with a CPU (not shown) and peripheral circuits thereof (not shown), the CPU executes the installed program. FIG. 20 presents a block diagram of the essential structure of the personal computer 10.

As shown in FIG. 20, the personal computer 10 comprises a control unit 110, a data storage device 111 and an external interface 112. The control device 110, which includes the CPU, a memory and other peripheral circuits, outputs control signals to the various units constituting the personal computer 10 in order to control the operation of the personal computer 10. In addition, the control unit 110 includes functional units such as a color space conversion unit 110A, a texture expression unit 110B, an edge synthesis unit 110C, a histogram generation unit 110D, a feature calculation unit 110E and an image classification unit 110F.

The color space conversion unit 110A converts image data expressed in an RGB color space to image data in an HVC color space. The texture expression unit 110B executes filtering processing on the image data resulting from the conversion. Namely, the texture expression unit 110B extracts a plurality of high-frequency subbands (edge component data) assuming varying resolution levels by executing multiresolution transformation processing to be detailed later. The edge synthesis unit 110C executes inverse multiresolution transformation on the high-frequency subbands having been generated so as to generate synthesized edge component data by integrating the high-frequency subbands into a single integrated image. The histogram generation unit 110D generates a histogram related to the intensity of the synthesized edge component data having been generated by the edge synthesis unit 110C. The feature calculation unit 110E calculates features related to the characteristics of the distribution pattern assumed in the histogram having been generated by the histogram generation unit 110D. The image classification unit 110F searches through and classifies image data recorded in the data storage device 111 by using the features having been calculated by the feature calculation unit 110E.

The data storage device 111 is a hardware device where various types of data including electronic image data are stored as described earlier. In response to a command issued by the control unit 110, various types of data (e.g., the electronic image data, the program or the like mentioned earlier) are received at the external interface 112 via the recording medium 104 or the communication line 101.

The following is a description of the model creation processing executed by the personal computer 10 and the image search processing executed by using perception models having been created by the personal computer. The model creation processing is executed for image files saved in, for instance, the storage device of the personal computer 10, prior to the image search processing.

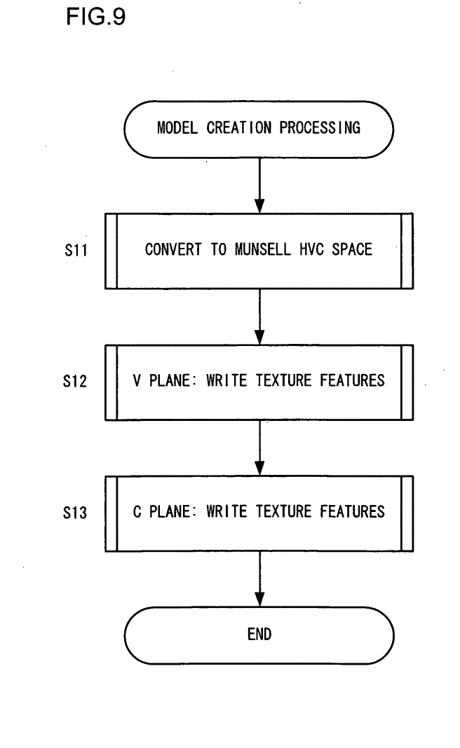

FIG. 9 presents a flowchart of the model creation processing executed by the personal computer (hereafter referred to as the PC) 10. The processing in FIG. 9 is executed when, for instance, an image file is saved into the storage device.

(1) Conversion from the RGB Space to the Munsell HVC Space

In step S11 in FIG. 9, the PC 10 converts the image data in an image file to image data expressed in the Munsell color space achieving a high level of color uniformity as perceived by the human eye. The Munsell color space, where the full range of hue H is divided into 100 different levels, the luminance V is distributed over levels 0˜10 and the chromaticity C is distributed over levels 0˜25, is designed so as to allow perception equivalency between V chrominance 1 and C chrominance 2.

Areas where C assumes values equal to or less than 1, V assumes values equal to or less than 0.5 and V assumes values equal to or greater than 9.5 are defined as N (neutral hue) areas. Image data expressed in the RGB color space can be converted to data in the HVC color space through mathematical approximation by first converting the image data to data in an XYZ space, as described in reference (*3). This conversion may be achieved by scrutinizing the definition of a specific uniform color space, i.e., the L*a*b* color space or the L*C*H* color space, and adopting an expression that will correct the insufficient color uniformity thereof.

### (*3) “Image Indexing and Retrieval Based On Color Histograms” by Y. Gong, C. H. Chuan and G. Xiaoyi, Multimedia Tools and Applications 2, 133-156 (1996)

Assuming that the input image is expressed in the sRGB color space output with specific gamma characteristics, the conversion into the Munsell HVC space is executed, after the target image data are first converted back to data assuming linear gradation and then are converted to data in the XYZ space in compliance with the sRGB specifications. Subsequently, the data are converted to data in the Munsell HVC space by assuming nonlinear gradation taking on cubic root characteristics, as expressed in the reference listed above (*3). The conversion is executed over four stages, i.e., step S11-1˜S11-4.

(Conversion to Linear Gradation sRGB)

In step S11-1, image data having undergone gamma correction, such as an sRGB image, are converted back to linear gradation data by undoing the gamma correction. The conversion is executed as expressed in (1).

$$\begin{matrix}{R}_{sRGB}^{linear} = {γ}^{- 1} ( {R}_{sRGB} ) \\ {G}_{sRGB}^{linear} = {γ}^{- 1} ( {G}_{sRGB} ) \\ {B}_{sRGB}^{linear} = {γ}^{- 1} ( {B}_{sRGB} )\end{matrix} \} \qquad ( 1 )$$

(Conversion to the XYZ Space)

In step S11-2, the RGB data having been converted back to linear gradation data are converted to data in the XYZ space. The conversion is executed as expressed in (2).

$$( \begin{matrix}X \\ Y \\ Z\end{matrix} ) = ( \begin{matrix}0.4124 & 0.3576 & 0.1805 \\ 0.2126 & 0.7152 & 0.0722 \\ 0.0193 & 0.1192 & 0.9505\end{matrix} ) ( \begin{matrix}{R}_{sRGB}^{linear} \\ {G}_{sRGB}^{linear} \\ {B}_{sRGB}^{linear}\end{matrix} ) \qquad ( 2 )$$

(Conversion to M1, M2 and M3 Spaces)

In step S11-3, the data in the XYZ space are converted to data in M1, M2 and M3 spaces. The conversion is executed as expressed in (3).

$$\begin{matrix}{H}_{1} = 11.6 \{ {( \frac{X}{{X}_{0}} )}^{1 / 3} - {( \frac{Y}{{Y}_{0}} )}^{1 / 3} \} \\ {H}_{2} = 11.6 \{ {( \frac{Y}{{Y}_{0}} )}^{1 / 3} - {( \frac{Z}{{Z}_{0}} )}^{1 / 3} \} \\ {H}_{3} = 11.6 {( \frac{Y}{{Y}_{0}} )}^{1 / 3} - 1.6 \\ {M}_{1} = {H}_{1} \\ {M}_{2} = 0.4 * {H}_{2} \\ {M}_{3} = 0.23 * {H}_{3}\end{matrix} \} \qquad ( 3 )$$

(Conversion to the HVC Space)

In step S11-4, the data in the M1, M2 and M3 spaces are converted to data in the HVC space. The conversion is executed as expressed in (4).

$$\begin{matrix}\overline{H} = arctan ( {M}_{2} / {M}_{1} ) \\ {S}_{1} = \{ 8.88 + 0.966 * cos ( \overline{H} ) \} * {M}_{1} \\ {S}_{2} = \{ 8.025 + 2.558 * sin ( \overline{H} ) \} * {M}_{2} \\ H = arctan ( {S}_{2} / {S}_{1} ) \\ V = 11.6 {( \frac{Y}{{Y}_{0}} )}^{1 / 3} - 1.6 \\ C = \sqrt{{S}_{1}^{2} + {S}_{2}^{2}}\end{matrix} \} \qquad ( 4 )$$

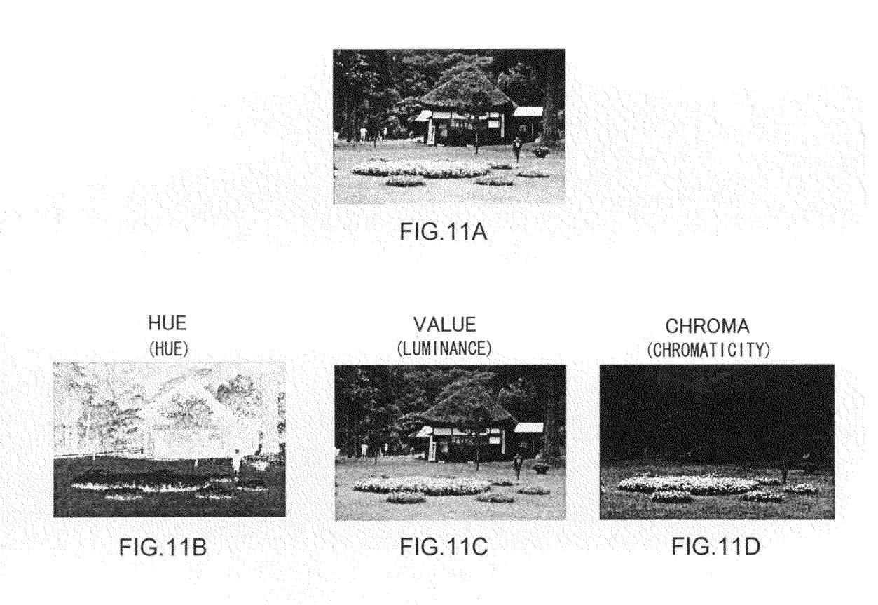

FIGS. 11A˜11D respectively present an example of a sample image expressed in the RGB space, a hue plane H, the luminance plane V and the chromaticity plane C that are generated by converting the sample image to data in the Munsell HVC. FIG. 11A shows the RGB image, FIG. 11B shows the hue plane image, FIG. 11C shows the luminance plane image and FIG. 11D shows the chromaticity plane image. The images in FIGS. 11B˜11D are generated through the procedure executed in steps S11-1˜S11-4 described above.

(2) V Plane: Description of Texture Features

In step S12, to which the operation proceeds after step S11, the PC 10 evaluates texture features on the luminance (V) plane. The texture feature evaluation procedure is executed over four stages, i.e., step S12-1˜step S12-4.

(Multiresolution Transformation and Edge Extraction)

In step S12-1, high-frequency edge component data in the luminance plane are extracted by projecting the luminance plan data into frequency spaces generated based upon multiresolution representation through wavelet transformation. The following description is given by assuming that high-frequency subbands LH, HL and HH resulting from wavelet decomposition are directly used as edge component data. The concept of this wavelet decomposition, executed up to resolution level M, may be expressed as in (5).

Vᵢⱼ(\vec{x})=Wavelet_{(i,j)}{S(\vec{x})}, (5)

i=1, 2, . . . , M (resolution)
j=LL, LH, HL, HH

The wavelet transformation may be executed by using, for instance, a 5/3 filter expressed below.

(Wavelet Transformation: Analysis/Decomposition Process)

High pass component: d[n]=x[2n+1]−(x[2n+2]+X([2n])/2
Low pass component: s[n]=x[2n]+(d[n]+d[n−1])/4

The one-dimensional wavelet transformation defined above is executed along the horizontal direction and the vertical direction independently through two-dimensional separation filter processing so as to achieve wavelet decomposition. The coefficient s is directed onto the L plane, whereas the coefficient d is directed onto the H plane.

While the wavelet transformation may be executed by using an even numbered tap-type high pass filter such as a 2/6 filter or a 2/10 filter assuming asymmetrical filter coefficients relative to the center defined as a first derivative or by using an odd-numbered tap-type high pass filter such as a 5/3 filter or a 9/7 filter assuming symmetrical filter coefficients relative to the center defined as a second derivative, it has been confirmed through testing that the second derivative-type filter with an even number of taps better fits the requirements of the present invention.

In addition, instead of directly using the high-frequency subbands LHi, HLi and HHi (i=1, 2, . . . M) resulting from the multiresolution transformation as the edge component data and the data obtained by further applying to the subbands the Laplacian filter that is an edge detection filter may be used as edge component data, instead. While the high-frequency subbands directly resulting from the wavelet transformation express a second derivative edge component, the high-frequency component obtained by further applying a second derivative Laplacian filter expresses a fourth derivative edge component data. As a further alternative, multiresolution transformation may be executed through a Laplacian pyramid method instead of the wavelet transformation.

The edge component data extracted by using a high pass filter as described above are detected on the luminance plane having undergone nonlinear gradation conversion through γ correction and thus, carries local contrast information. Namely, information equivalent to information representing a retinex mechanism whereby the ratio of local average luminance and the luminance level of the target pixel in the linear gradation data calculated for purposes of gradation correction, is recognized as the contrast in the particular local area as human visual perception becomes adapted to the local area, is extracted. The edge component data extracted at multiple resolution levels can be regarded as contrast information provided in multiscale retinex representation. The retinex theory is described in, for instance, reference (*4).

(*4) “Analysis of the retinex theory of color vision” by E. H. Brainard and B. A. Wandell, J. Opt. Soc. Am. A, Vol 3, No. 10, October 1986, pp 1651-1661

In addition, reference (*5) states that the histogram (referred to as a probability density function, abbreviated to pdf as described earlier) of high-frequency band signal values generated through the multiresolution transformation described earlier assumes a Gaussian distribution pattern or a Laplacian distribution pattern. Under normal circumstances, the pdf distribution pattern can be approximated with the symmetrical generalized Gaussian distribution pattern.

(*5) “Source Coding With Channel, Distortion and Complexity Constraints,”, by Michael J. Gormish, doctoral thesis, Stanford University, March 1994, chapter 5: “Quantization and Computation•Rate•Distortion”.

The M representing the number of stages over which the multiresolution transformation is executed should be set so that the data are decomposed to a stage corresponding to a specific resolution assuming a number of pixels at which the pdf histograms of the individual bands remain reasonably stable. For instance, a Quad space VGA-size (1280×960) image may undergo five-stage multiresolution decomposition, a QVGA-size (320×240) image may undergo three-stage multiresolution decomposition and an image constituted with 20,000,000 pixels may undergo seven-stage multiresolution decomposition.

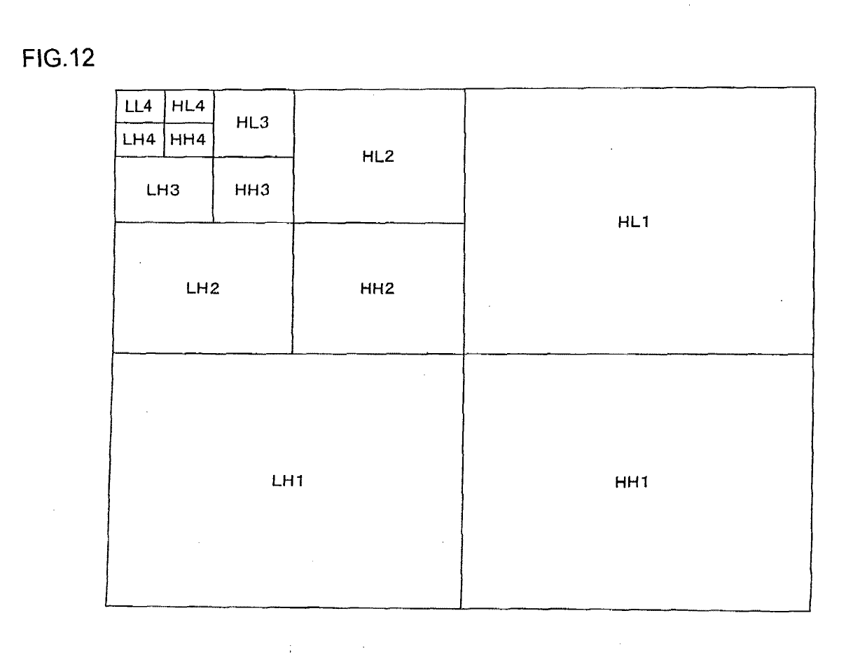

FIG. 12 illustrates how the target data may be divided into subbands through four-stage wavelet transformation. For instance, the image data in the real space undergo the first-stage wavelet transformation so as to extract high pass component data and low pass component data from all the rows along the horizontal direction. As a result, high pass component data and low pass component data each constituted with pixels, the number of which equals half of all the pixels set side by side along the horizontal direction, are extracted. The high pass component data and the low pass component data are then stored on the right side and on the left side respectively relative to the memory area where the image data in the real space exist.

Next, high pass component data and low pass component data are extracted both from the high pass component data stored on the right side of the memory area and the low pass component data stored on the left side of the memory area in correspondence to all the columns extending along the vertical direction. As a result, high pass component data and low pass component data are extracted from both the high pass component data stored on the right side of the memory area and the low pass component data stored on the left side of the memory area. These extracted high pass component data and low pass component data are respectively stored on the lower side and the upper side of the memory areas where the corresponding data have been stored.

As a result, HH represents data extracted as high pass component data along the vertical direction from data having been extracted as high pass component data along the horizontal direction, HL represents data extracted as low pass component data along the vertical direction from data having been extracted as high pass component data along the horizontal direction, LH represents data extracted as high pass component data along the vertical direction from data having been extracted as low pass component data along the horizontal direction and LL represents data extracted as low pass component data along the vertical direction from data having been extracted as low pass component data along the horizontal direction. However, since the vertical extraction and the horizontal extraction are executed independently of each other, identical results are also achieved when the data extraction is executed in the reverse order.

Next, in the second-stage wavelet transformation, high pass component data and low pass component data are likewise extracted from the data LL having been extracted as low pass component data along the vertical direction from the data extracted as the low pass component data along the horizontal direction through the first-stage wavelet transformation. As this process is repeatedly executed through the fourth stage, the subband images shown in FIG. 12 are obtained.

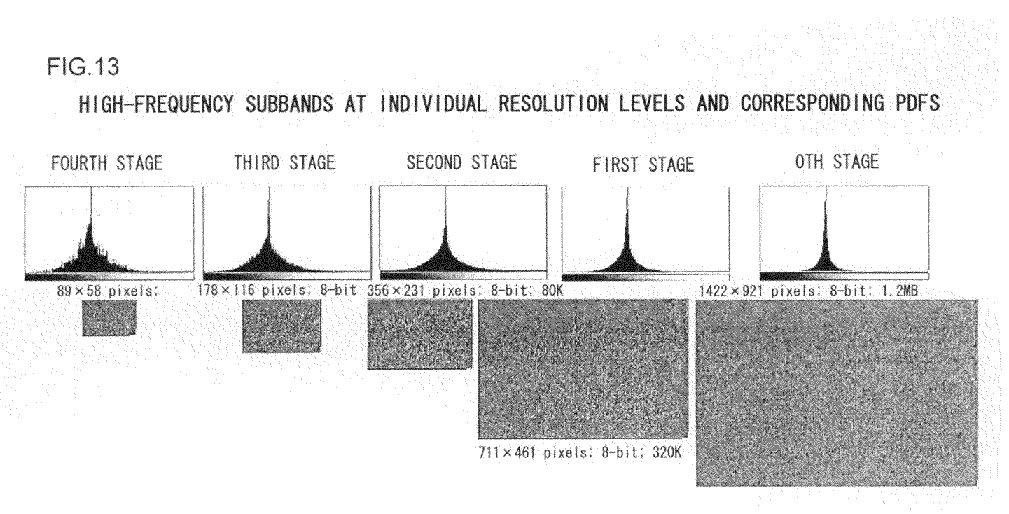

FIG. 13 shows high-frequency subband planes at various resolution levels and the distribution patterns of the corresponding probability density functions (pdfs). The pdf forms corresponding to the individual stages are shown on the upper side and the corresponding subband planes are shown on the lower side. They all correspond to the sample image shown in FIGS. 2A˜2C.

(Multiresolution Synthesis)

The high-frequency subbands extracted as described above carry information related to edges, textures and contrast at the individual resolution scales. In step S12-2, the high-frequency subbands alone undergo inverse multiresolution transformation for edge synthesis so as to facilitate handling of the different types of information as one. Namely, the low-frequency subband LLM assuming the lowest resolution level is excluded with the signal values therein all set to 0, and then the remaining high-frequency subbands sequentially undergo inverse wavelet transformation. This concept may be expressed as in (6) below with E representing the synthesized edge component data assuming a resolution level matching that of the input image.

$$E ( \overline{x} ) = {\sum }_{{i = LH , HL , HH}_{j = M , M - 1 , … , 2.1}} {Wavelet}^{- 1} \{ {V}_{ij} ( \overline{x} ) \} \qquad ( 6 )$$

During the synthesis stage, the edge, texture and contrast information in a specific hierarchical layer is passed on to the next hierarchical layer by taking into consideration the spatial positional relationship. It is to be noted that if the synthesis is executed by adopting the Laplacian pyramid method, the Gaussian plane at the lowest resolution level should be set to 0 and the remaining Laplacian planes should be sequentially integrated.

(Creating a Synthesized Edge Histogram (pdf))

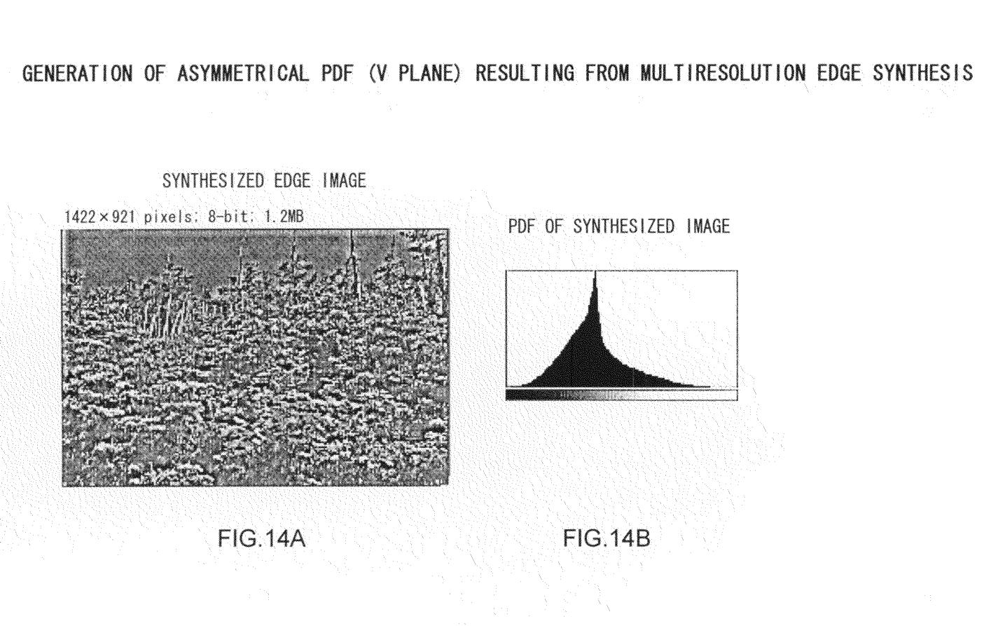

In step S12-3, a histogram of the synthesized edge component data, i.e., the probability density function (pdf), is created. The pdf, which is an edge intensity histogram, assumes a distribution pattern peaking at the origin point with substantially equal frequency integrated areas on the positive side and the negative side. Generally speaking, a memoryless source with no correlation among different resolution levels manifesting a symmetrical pdf distribution pattern in each hierarchical layer will retain the symmetrical pdf distribution pattern after the synthesis. However, if a correlation exists among the resolution levels, the correlation can be reflected in the pdf distribution pattern. FIGS. 14A and 14B show how an asymmetric pdf distribution pattern may be formed through edge synthesis executed for an image assigned with the adjective “gallant”, i.e., an image in the “masculine” group.

FIG. 14A shows the synthesized edge image generated by integrating the high-frequency subbands shown on the lower side of FIG. 13, and FIG. 14B shows the pdf distribution pattern corresponding to the image in FIG. 14A. It is to be noted that the illustrations in FIGS. 14A and 14B are provided by offsetting (=100) the origin point for purposes of illustration clarity. It has been confirmed through testing that the pdf distribution pattern of such a synthesized edge image takes on a shape as the edge component data at the lowest resolution level through, for instance, third-stage resolution are integrated. This means that if the processing needs to be simplified, the pdf distribution pattern obtained at an intermediate stage of the synthesis process may be evaluated instead of integrating edge component data through the final resolution level corresponding to that of the actual image.

(Calculation of Luminance Plane Features)

A primary feature that characterizes a pdf distribution pattern is its asymmetry. A tertiary moment of the histogram, referred to as “skew factor” in mathematical terms, may be used as an index representing the asymmetry. However, through testing, it has been revealed that the skew factor has particular sensitivity to the characteristics manifesting in the “tail” areas (lower limits) of the curve where data are distributed in lower frequencies, which tends to lead to under-evaluation of the asymmetry over a central area where data are concentrated with high frequency, and a failure to reflect the impression manifested along the direction of the asymmetry in the overall histogram. Accordingly, the concept of “eboshi factor”, which is determined through testing, is adopted as another index to be used to evaluate the asymmetry of the histogram. The word “eboshi” is taken from the name of a particular headgear worn by courtesans in the Heian Era in Japan, which the histogram distribution pattern resembles.

While the skew factor is an index sensitive to the characteristics manifesting over the tail areas, the eboshi factor may be regarded as an index relatively insensitive to the characteristics over those areas. The characteristics manifesting over the tail areas hold latent potential for enabling a more advanced analysis of the histogram form. Generally speaking, each adjective used as a perception term functions both as an element indicating a collective category that includes a plurality of adjectives with similar meanings and as an element distinguishing the particular word from the other adjectives in the category. For instance, in an adjective category that includes the adjective “merry” will also include “bustling”, “vibrant” and “flashy” in addition to “merry” itself. Accordingly, it would appear to be a rational approach to evaluate the characteristics of a given aspect of the image by using two types of features for impression-indexed classification, one that indicates the overall character of the image and the other enabling finer classification.

In step S12-4, features indicating the asymmetry of the luminance plane data are calculated as described below.

(i) Definition of the Eboshi Factor

The eboshi factor is used to evaluate the degree of symmetry distortion with the offset of the central coordinate point of the full width at half maximum (FWHM) of the histogram relative to the origin point and the offset of the central coordinate point of the full width at population 95% (FWP95), measured at a point corresponding to an areal ratio of 95% by integrating the data in the histogram downward along the vertical axis from the peak point, relative to the origin point factored in, in combination. Namely, the eboshi factor is expressed as in (7) below.

eboshi degree=(central position of FWP95)(central position of FWHM) (7)

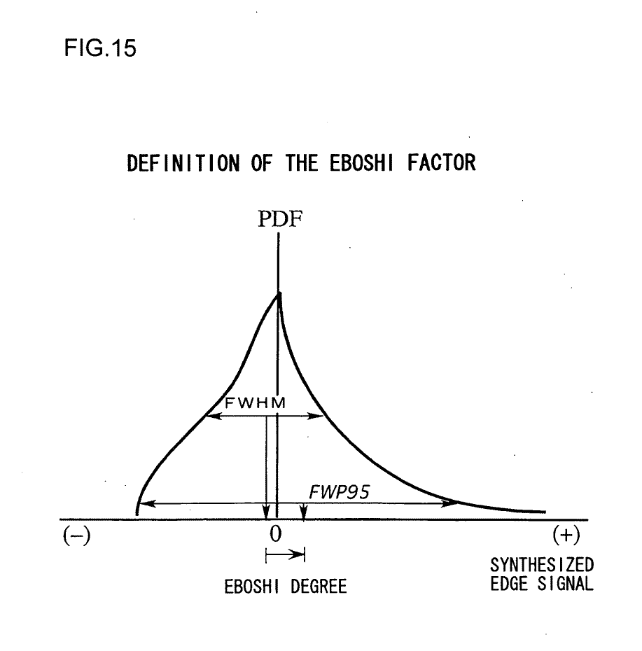

When a tail area has an expanse over the positive range, the eboshi factor is likely to take on a positive value and the value increases as the degree of distortion attributable to the expanse increases. In addition, the distortion in the central area where data concentrate with higher frequency is evaluated based upon the FWHM. If the data around the central area swells over the negative range, the eboshi factor is also likely to indicate a positive value. Thus, the pdf distribution resembles the eboshi headgear facing toward the left when the eboshi factor assumes a positive value, whereas it resembles the eboshi head gear facing toward the right when the eboshi factor assumes a negative value. FIG. 15 presents a diagram illustrating how the eboshi factor may be defined.

(ii) Definition of the Skew Factor

p(x) represents a probability density function for pdf generated through normalization based upon the total pdf integral and x represents the edge intensity indicated along the horizontal axis. The average value ave may be calculated as expressed in (8), the standard deviation σ may be calculated as expressed in (9) and the skew factor (skewness) may be calculated as in (10).

### Average Value Ave

$$\overline{x} = {\int }_{- ∞}^{+ ∞} xp ( x ) d x \qquad ( 8 )$$

### Standard Deviation σ

$${σ}^{2} = {\int }_{- ∞}^{+ ∞} {( x - \overline{x} )}^{2} p ( x ) d x \qquad ( 9 )$$

### Skew Factor (Skewness)

$${γ}_{1} = {\int }_{- ∞}^{+ ∞} {( x - \overline{x} )}^{3} p ( x ) d x / {σ}^{3} \qquad ( 10 )$$

Since the average value invariably takes on a value close to 0, it may be preset to 0. The eboshi factor and the skew factor thus defined are used as features indicating the asymmetric property of the pdf distribution pattern.

(3) C Plane: Description of Texture Features

In step S13, to which the operation proceeds after step S12 in FIG. 9, the PC 10 evaluates texture features on the chromaticity (C) plane. Since the pdf distribution pattern obtained for the chromaticity C plane demonstrates characteristics similar to those of the pdf distribution pattern obtained for the luminance V plane, at least the asymmetry of the pdf distribution pattern can be likewise evaluated by using the eboshi factor and the skew factor. The texture feature evaluation procedure is executed through a four-stage procedure similar to that executed in steps S12-1˜step S12-4.

Upon finishing processing in step S13, the PC 10 writes the various features, having been calculated through the processing executed in steps S11˜S13, as feature information into an image file in correspondence to the thumbnail image data of the particular image, then records the image file as a image registered as a search target into the data storage device, before ending the model creation processing.

(4) Texture Feature Models for Adjectives

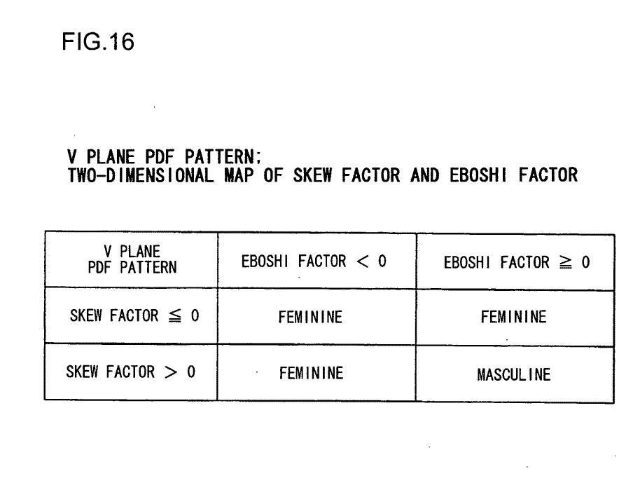

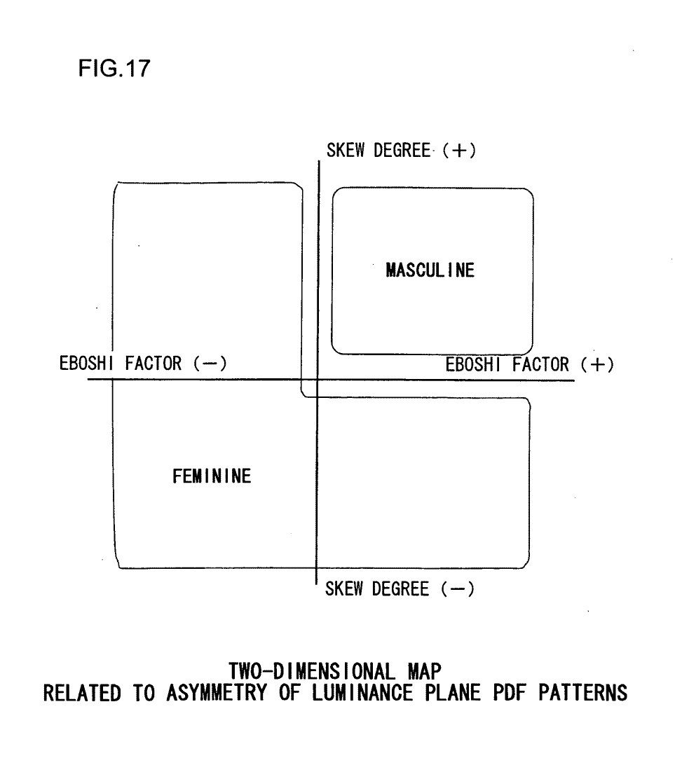

Through the processing described above, perception models used to classify images as “masculine” or “feminine” based upon the texture features thereof are created. The following description relates to the asymmetry of pdf distribution patterns generated from V plane data. As has been described earlier in “creation of kansei models or perception models”, the pdf distribution pattern of a typical “masculine” image resembles the shape of the eboshi headgear facing left. The features representing this form, i.e., the eboshi factor and the skew factor indicating the asymmetry, both indicate positive values. However, the pdf of a “feminine” image tends to assume a complex and delicate distribution pattern and, for this reason, not only in case that an image with either the eboshi factor or the skew factor thereof indicates a negative value, but also in case that one of the eboshi factor and the skew factor takes on negative values, may have feminine attributes, as has been statistically confirmed based upon the evaluation data. Accordingly, a two-dimensional map of the skew factor and the eboshi factor may be created as shown in FIGS. 16 and 17. FIG. 16 shows a two-dimensional map table related to the asymmetry (indicated by the skew factor and the eboshi factor) of the V plane pdf form, whereas FIG. 17 presents an example of a two-dimensional map.

While images are classified either as “masculine” or “feminine” through the classification method described above, the characteristics of images with the pdf distribution patterns thereof manifesting no asymmetry are now scrutinized. The pdf distribution pattern is an index reflecting the spatial distribution of contrast. Accordingly, while a symmetrical image with the eboshi factor thereof indicating exactly 0 may manifest no correlation at all, the eboshi factor at 0 more often indicates that the photograph assumes a very balanced contrast distribution with correlation manifested and symmetry sustained within the image. This means the photograph is likely to be a high-scoring image with good overall composition, likely to be found pleasing by most people. It is to be noted that such a high score is still awarded to a photograph based upon the evaluation executed by assigning the photograph either to the “masculine” group or the “feminine” group.

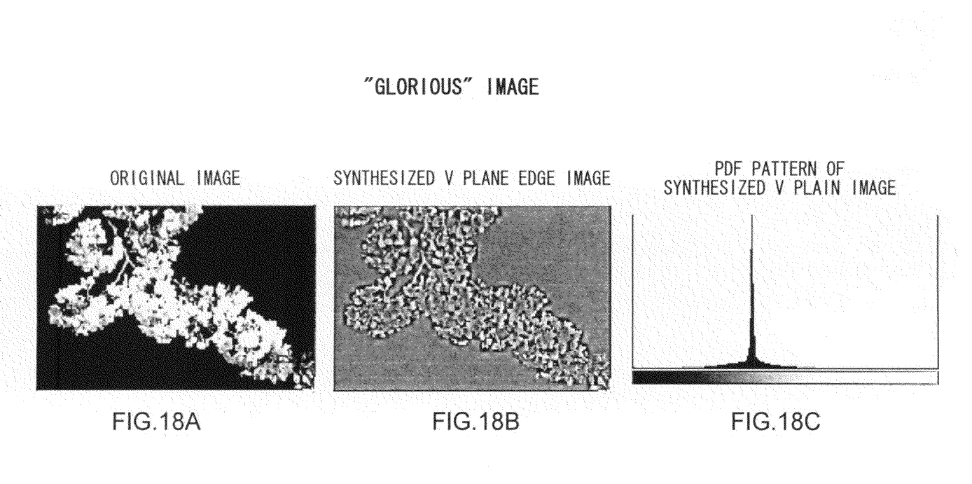

While the classification described above is executed based upon perception models created by analyzing the asymmetry in the pdf distribution patterns, another likely connection between pdf distribution patterns and numerous adjective elements is explained by citing as an example the pdf distribution pattern generated from the luminance plane data of an image assigned with the adjective “glorious”. FIGS. 18A˜18C present an example of a sample image assigned with the adjective “glorious”. FIG. 18A shows the original image. FIG. 18B shows the synthesized edge image obtained from the V (luminance) plane data. FIG. 18C shows the distribution pattern of the probability density function (pdf) for the synthesized edge image. The figures indicate that the amount of tail area in the pdf distribution pattern and the narrow pointed peak in the central area are likely to have contributed to the visual impression made by the image.

While the features used to create perception models based upon the luminance plane pdf distribution patterns have been discussed so far, perception models may be created for the pdf distribution patterns corresponding to chromaticity plane data through similar reasoning. By using the features corresponding to the luminance plane data and the chromaticity plane data in combination, the assignment of a more complex and a greater number of adjectives will be enabled. Furthermore, in addition to the features representing the pdf distribution patterns defined above, another features representing the pdf distribution patterns in further detail may be defined. Moreover, the positive range and the negative range of each pdf distribution pattern may be separately fitted with the generalized Gaussian function so as to describe the characteristics of the particular pdf distribution pattern based upon a power exponent parameter indicating approximation of the particular distribution pattern between a Laplacian distribution and a Gaussian distribution and a standard deviation indicating the spread of the distribution.

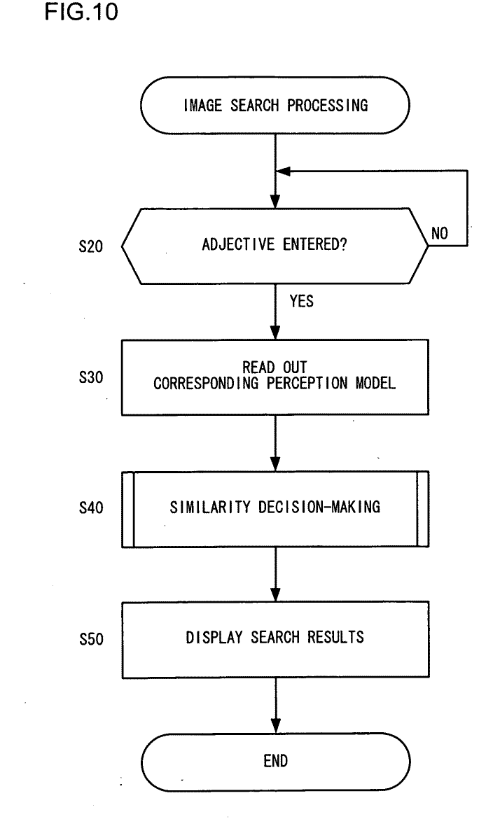

The feature information saved in image files as described above is used in similarity decision-making executed in step S40 as part of the image search processing described below. As the image search processing program is started up, the PC 10 executes the processing as shown in FIG. 10. In step S20 in FIG. 10, the PC 10 makes a decision as to whether or not an adjective has been entered. If an adjective based upon which an image search is to be executed has been entered via a keyboard or a pointing device, the PC 10 makes an affirmative decision in step S20 and the operation proceeds to step S30. If no adjective has been entered, the PC 10 makes a negative decision in step S20 and the operation returns to step S20.

In step S30, the PC 10 reads out from the database each perception model corresponding to the adjective (e.g., “masculine”) by referencing the skew factor/eboshi factor two-dimensional map recorded in advance in the data storage device and then the operation proceeds to step S40. In step S40, the PC 10 executes similarity decision-making.

The similarity decision-making is executed by comparing the feature information for the images having been registered in the data storage device as registered images with the perception model values (feature values) having been read out in step S30. If an image the features of which have not been previously calculated is selected as a search target, the features should be calculated as needed. Namely, after projecting the search target input image into the feature spaces through the processing executed in steps S11˜S13, its similarity to the perception model having been created in correspondence to the search keyword adjective as described in (4) is measured by comparing distances in the feature space so as to make a decision as to whether or not the input image gives an impression aptly described by the search keyword adjective.

In step S50 in FIG. 10, the PC 10 brings up on display the search results at the screen of a display unit before ending the processing in FIG. 10. The search results are provided by displaying thumbnail images matching the search keyword side-by-side. Namely, a thumbnail list of the thumbnail images corresponding to image files assuming features determined to match the adjective, among the image files registered in the data storage device, is brought up on display at the display screen.

The following advantages are achieved through the embodiment described above.

(1) Since it has been shown that when a single set of synthesized high-frequency component data obtained by sequentially integrating high-frequency component data extracted at multiple resolutions levels contains a single set of data therein information related to the edges, the texture and the contrast in the overall image as integrated information quantities reflecting the spatial positional relationship, factors allowing viewers to receive perceptional impressions invoked by completely different scenes statistically tend to form specific histogram patterns in correspondence to the high-frequency component data of the images, then the histogram patterns can be used as abridged features optimal for the impression-indexed classification of photographic images. As a result, it becomes possible to classify photographic images through advanced impression-indexed classification assuring a high level of accuracy in adjective-based sorting.

(2) In an actual impression-indexed search experiment conducted to classify images as “masculine” or “feminine” by using evaluation data pairing up images with corresponding adjectives prepared in advance, the images were accurately matched up with the corresponding adjectives through “classification based upon broadly interpreted adjectives”, proving that image search can be executed by very closely approximating human perception according to the present invention.

For instance, the accuracy of the classification was substantiated by the fact that the images classified as “feminine” included photographic images of subjects nested against expansive backgrounds. While a human viewer would receive an overall impression of an image having both a masculine element and a feminine element based upon the more dominant element of the two, some of the search results indicated that the search had been executed in a manner similar to this. For instance, in one target image representing that an intense evening sun is about to set over an ocean horizon, while the glare of the sun is forceful and manly, the sun takes up a small area in the image and the expanses of the surrounding ocean and sky are the dominant factor invoking a mild, enveloping impression for the overall photographic image and thus the pdf distribution pattern demonstrated the feminine element as the dominant element compared to the masculine element and since the pdf distribution pattern indicated feminine characteristics overall, the image was accurately classified as “feminine”.

(3) Compared to the related art disclosed in reference 1, whereby images are approximated through trichromatic representation, a dramatic improvement is achieved since the present invention assumes a completely different feature axis. For instance, in correspondence to the adjective “masculine”, images with characteristics matching the perceived manly attributes in terms of contrast and scale are accurately selected irrespective of their hues, instead of selecting only images with dark hues simply associated with male gender attributes.

(4) In addition, a “delicate” image that would be broadly categorized as “feminine”, such as an image of a delicate flower photographed against a dark background, would be determined to be “masculine” in the related art due to the overall dark hue. However, the image was categorized as “feminine” as implied by the impression adjective in the embodiment.

(5) The histogram distribution pattern of synthesized edge component data generated by integrating edge component data extracted at multiple resolutions levels as described above indicates features that allow an integrated analysis of the contrast, both on local scales and on the global scale. Thus, it is assumed that physical quantities that can be used as abridged indices representing the human perception characteristics, having a high level of correlation to the workings of the human brain as it perceives and recognizes visual characteristics, are provided in the form of these features.

(6) Since the existence of such abridged texture features assuring a high level of correlation to adjectives was discovered and thus it has become possible to analyze image characteristics in the feature spaces, a more advanced impression-indexed image search is enabled.

(7) The PC 10 stores reference data used to distinguish the pdf distribution pattern of a specific set of synthesized edge component data obtained by integrating edge component data extracted at multiple resolutions levels in the data storage device as perception models in correlation to adjectives expressing impressions likely to be invoked by images. Then, based upon information indicating a specific adjective having been entered, the PC searches for images similar to the reference data correlated to the particular adjective. Since the pdf distribution patterns are compared, the need for having to compare images with a huge number of trichromatic representation models correlated with impression adjectives, as in the related art is eliminated and instead, images can be classified into groups corresponding to adjectives closely expressing impressions received by human viewers.

In addition, since the perception models are created in the form of a two-dimensional map indicating the correspondence between adjectives and features (reference data) representing specific pdf distribution patterns, comparison can be executed based upon features closely correlated to specific adjectives, instead of directly comparing the pdf distribution patterns themselves. In addition, since the comparison is executed based upon more abridged features, the search can be executed very easily.

(8) Since the asymmetry of a pdf distribution pattern is indicated by using the skew factor, pdf distribution pattern match-up (similarity) can be determined by comparing the skew factor values.

(9) Since the asymmetry of a pdf distribution pattern is indicated by using the eboshi factor, pdf distribution pattern match-up (similarity) can be determined by comparing the eboshi factor values.

(Variation 1) Other Texture Features

While the texture features used in the embodiment represent the pdf distribution pattern of the synthesized edge component data obtained by integrating the edge component data extracted at multiple resolutions levels, the patterns of the pdf distributions corresponding to the edge component data extracted at the various resolutions levels, too, may be used as texture features under certain circumstances. Namely, since the pdf distribution patterns corresponding to the individual resolution levels are assumed to manifest lesser extents of asymmetry, a feature vector (1, 2, . . . M) should be set by plotting the features calculated by using the distribution width as an index in succession in correspondence to the individual resolution levels. In addition, sets of information indicating whether the pdf distributions corresponding to the individual hierarchical layers each better approximate the Laplacian distribution or the Gaussian distribution may be plotted in succession. However, the texture feature information provided in this manner do not reflect the correlation among the spatial positions corresponding to the various resolution levels and the volume of information indicating such texture features is bound to be large enough to be considered redundant.

(Variation 2) Statistical Examination of Models

While pdf distribution patterns are each converted to a feature such as the eboshi factor or the skew factor to enable classification/comparison of the pdf distribution patterns in the embodiment described above, the pdf histogram distributions themselves may each be directly used as a feature, and then an input image should be matched with a specific model during the classification processing through histogram distribution pattern matching.

(Variation 3)

As a further alternative, models may be created by statistically examining features representing model pdf patterns. In such a case, statistics may be generated by asking a plurality of human viewers to determine whether or not each image matches any of the adjectives listed as search target adjectives and the system may be trained to learn typical distribution patterns by weighting images assuming high match-up levels for a given adjective so as to average the pdf distributions. As an alternative, statistical averages may be taken in a feature space related to the distribution patterns.

(Variation 4) Standardization of Perception Determined Discriminant Function

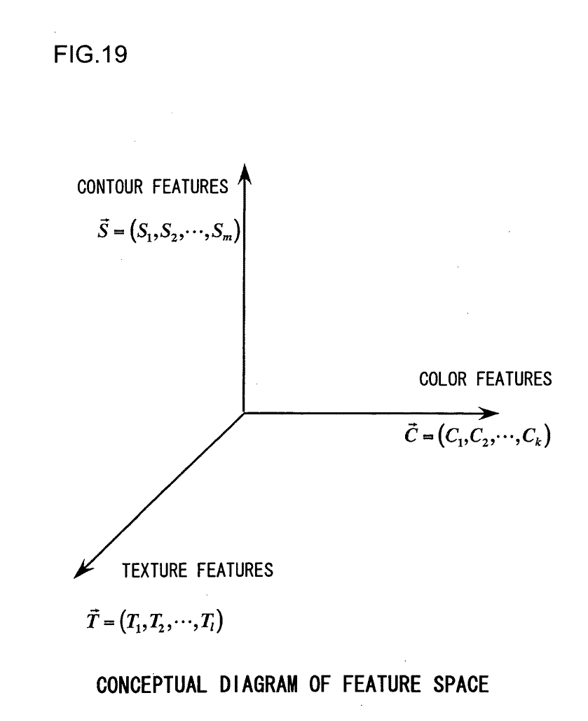

While the texture features are primarily analyzed as features affecting human perception in the embodiment, it is believed that there are several other feature axes independent of texture, which are also directly related to human perception. Such feature axes may include, for instance, a color feature axis and a contour feature axis. It is surmised in relation to color features that vectors providing several or more than 10 features closely connected to human perception, such as a value indicating the representative hue, a value indicating the areal ratio of the representative hue and a feature related to the luminance or the chromaticity, can be generated. By combining such an alternative feature axis with the texture feature axis in building up a perception discriminant function for various adjectives, a greater range and variety of adjectives can be used in the classification to contribute toward an improvement in the classification/discrimination accuracy. The concept of this expanded application may be expressed as in (11) below. In addition, FIG. 19 schematically illustrates the concept of the expanded application.

Pi=Fi (texture features; color features; contour features; . . . ) (11)

Pi represents the probability of the target image matching the adjective i, whereas Fi indicates a function used to distinguish the adjective i. The arguments in the discriminant function are separated from one another with a semicolon (;), since a feature vector representing the aggregate of several types of features, as illustrated in FIG. 19, is assumed.

In addition, when investigating a specific chromatic attribute of the target image, based upon the concept described in relation to the texture features, for instance, an insensitive index and a sensitive index may be used in combination when analyzing the histogram distribution patterns corresponding to the color-related luminance and the color-related saturation, to achieve an improvement in adjective-based classification performance. In other words, the chromatic characteristics of the target image may be broadly and stably classified and, at the same time, assigned with an adjective indicating a subtle delicate nuance.

(Variation 5)

The image search apparatus described above automatically searches for images matching the input adjective among a plurality of preregistered images. By reversing this process, an adjective search apparatus capable of searching for an adjective matching the impression invoked by an input image based upon a perception model list saved in the data storage device of the PC 10 may be configured. In such a case, the feature information (comparison data) should be obtained through calculation executed for the newly input image data through the processing in step S11˜S13.

Then, by sequentially comparing the features (comparison data) calculated for the input image with the features (reference data) in the two-dimensional map described earlier, the adjective corresponding to the features (reference data) close to the features of the image (comparison data) is automatically searched.

By attaching a tag indicating the retrieved adjective to the image file, an image classification apparatus capable of adjective indexing can be configured. In this case, a tag indicating “masculine” is attached to each image file matching the adjective “masculine” and a tag indicating “feminine” is attached to each image file matching the adjective “feminine”. In addition, a tag indicating a plurality of adjectives may be attached to an image matching a plurality of adjectives.

The above described embodiment is an example and various modifications can be made without departing from the scope of the invention.

What is claimed is:

1. An image classification apparatus that classifies images based upon image data, comprising:
a multiresolution representation unit that sequentially generates high-frequency band images assuming a plurality of resolution levels by filtering an original image;
an image synthesis unit that synthesizes a single high-frequency band image by sequentially integrating the high-frequency band images starting with a high-frequency band image at the lowest resolution;
a histogram generation unit that generates a histogram of synthesized high-frequency band image signal; and
an image classification unit that classifies the original image into one of at least two image categories based upon a distribution pattern of the histogram having been generated.

2. An image classification apparatus according to claim 1, wherein:
the image classification unit classifies the original image based upon an asymmetry of the distribution pattern of the histogram.

3. An image classification apparatus according to claim 2, wherein:
the image classification unit indicates the asymmetry of the distribution pattern of the histogram as a feature representing a skew factor of the histogram.

4. An image classification apparatus according to claim 2, wherein:
the image classification unit indicates the asymmetry of the distribution pattern of the histogram as a feature representing offsets of central coordinate points of distribution widths at least at two specific heights relative to a height of a central peak in the histogram.

5. An image classification apparatus according to claim 1, wherein:
the image synthesis unit synthesizes the high-frequency band image by integrating high-frequency band images assuming at least three different resolution levels.

6. An image classification apparatus according to claim 1, wherein:
the image classification unit classifies an impression received from a single image as a whole into adjective.

7. An image classification apparatus according to claim 1, wherein:
the histogram generation unit generates the histogram of the synthesized high-frequency band image signal for one of a luminance plane and a chromaticity plane, or for both the luminance plane and the chromaticity plane.

8. An image classification apparatus according to claim 1, wherein:
the multiresolution representation unit makes characteristics of perceptively uniform contrast signals reflected in the high-frequency band images by generating the high-frequency band images in a nonlinear gradation uniform color space.

9. An image classification apparatus that classifies images based upon image data, comprising:
a multiresolution representation unit that sequentially generates high-frequency band images assuming a plurality of resolution levels by filtering an original image;
an image synthesis unit that synthesizes a single high-frequency band image by sequentially integrating the high-frequency band images starting with a high-frequency band image at a lowest resolution; and
an image classification unit that classifies an impression that human viewers receive from the original image into an adjective based upon the synthesized high-frequency band image.

10. An image classification apparatus that classifies images based upon image data, comprising:
a histogram generation unit that generates a histogram of image signals having projected therein specific characteristics of an original image;
a feature calculation unit that calculates a feature used to distinguish a given single type of pattern characteristics among patterns of the histogram having been generated; and
an image classification unit that classifies an impression that human viewers receive from the original image into an adjective based upon the feature, wherein:
the feature calculation unit calculates at least two different types of indices as features for distinguishing the single type of pattern characteristics.

11. An image classification apparatus according to claim 10, wherein:
the feature calculation unit calculates an index sensitive to part of the characteristics of the histogram and an index less sensitive to the part of the characteristics of the histogram as the two different types of indices.

12. An image classification apparatus according to claim 11, wherein:
the feature calculation unit calculates two types of features, one constituting an index sensitive to characteristics manifesting over a tail area in the histogram pattern and another constituting an index less sensitive to the characteristics assumed in the tail area in the histogram pattern as features used to distinguish the asymmetry of the histogram.

13. An image classification apparatus according to claim 10, wherein:
the feature calculation unit calculates an index related to a third-order or higher-order moment for an average value of the histogram and an index related to a quantity that can be defined by measuring coordinates of a distribution range at a predetermined height relative to a peak of the histogram as the two different types of indices.
